(19) United States
(12) Patent Application Publication
(10) Pub. No.: US 2017/0154357 A1
(43) Pub. Date: Jun. 1, 2017

(54) ONLINE FREQUENCY CAP SIMULATION

(71) Applicant: LinkedIn Corporation, Mountain View, CA (US)

(72) Inventors: Zhifeng Deng, Mountain View, CA (US); Siyu You, Santa Clara, CA (US); Xiaokang Zhang, Sunnyvale, CA (US); Manoj Rameshchandra Thakur, Sunnyvale, CA (US); Jan Schellenberger, Belmont, CA (US)

(21) Appl. No.: 14/958,574

(22) Filed: Dec. 3, 2015

Related U.S. Application Data
(60) Provisional application No. 62/261,088, filed on Nov. 30, 2015.

(51) Int. Cl. G06Q 30/02; G06F 17/30

(52) U.S. Cl. CPC G06Q 30/0246; G06F 17/30342

(57) ABSTRACT

Disclosed in some examples, are methods, systems, and machine readable mediums which allow for providing estimated impressions for content given arbitrary frequency caps. Time series historical visit data about each targeted user group is condensed by calculating, for each user in a targeted user group, an arrival rate. The arrival rates for each user in the targeted user group are used to construct a distribution of arrival rates in the user group. Given an arbitrary frequency cap, the system samples a large number of arrival rates N from the targeted user group. For each of the N sampled arrival rates, a time series corresponding to the arrival rate is created from that arrival rate and a frequency cap is applied to the sampled time series' to arrive at an estimated impression count. Adding up the frequency capped impressions for each sampled arrival rate and normalizing it for the number of members in the targeted population yields a prediction of the number of impressions in a given time period.

### PRIORITY

This patent application claims the benefit of priority to U.S. Provisional Patent Application Ser. No. 62/261,088, entitled “Online Frequency Cap Simulation,” filed on Nov. 30, 2015, which is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright LinkedIn, All Rights Reserved.

### TECHNICAL FIELD

Embodiments pertain to frequency cap simulation for delivery of online content. Some embodiments relate to online frequency cap simulation for delivery of online content using arbitrarily chosen frequency caps.

### BACKGROUND

Online content platforms, such as social networking services, provide targeted content to users based upon their demographic characteristics over a computer network (such as the Internet). This content may be delivered as part of one or more web-pages or web-based-applications delivered to one or more users over the computer network.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram showing the components of an online content platform, such as a social networking service.

FIG. 2, is a flowchart of a method of offline, batch processing of data used to produce an estimated number of impressions according to some examples of the present disclosure.

FIG. 3 is a flowchart of a method of providing estimated impressions given an arbitrary frequency cap according to some examples of the present disclosure.

FIG. 4 is a flowchart of a method of a monte-carlo simulation according to some examples of the present disclosure.

FIG. 5 is a flowchart of a method of a monte-carlo simulation according to some examples of the present disclosure.

FIG. 6 is a block diagram illustrating an example of a machine upon which one or more embodiments may be implemented.

### DETAILED DESCRIPTION

In the following, a detailed description of examples will be given with references to the drawings. It should be understood that various modifications to the examples may be made. In particular, elements of one example may be combined and used in other examples to form new examples.

Content providers who wish to put their content on a content platform may specify a “campaign,” which defines attributes corresponding to when, where, and how the content is shown. For example, a campaign may define one or more items of content to be shown, targeting criteria (attributes of users of the online content platform that get the content), date ranges with which the campaign is valid, and in some examples, frequency caps which specify limits to how many times a campaign's content is presented to users during a particular time period. In one example, the content may be advertising. Each time the content is shown to users is called an “impression.” In the case where the content platform is a social networking service, the targeting criteria specifies one or more attributes of a member or user of the social networking service. In some examples, content providers pay the content platform each time an impression is served to a user of the content platform. Frequency caps therefore serve an important purpose to limit the total cost of the campaign. Additionally, frequency caps may be used to enhance a user's experience on the content platform. For example, a campaign that is not capped and is shown too many times to a user may be tiresome and annoying for the user. Thus frequency caps are an important aspect of content campaigns.

Determining the proper targeting criteria and the proper frequency cap in order to properly budget for a content campaign may be a difficult task. Primarily, it is difficult to know in advance how many impressions will be generated. This is because the supply of possible web-pages to serve impressions on depends on user traffic to the online content platform. Web-pages to serve impressions are only delivered when a user visits the online content platform, and users of these platforms, as a whole, do not always follow regular patterns. Thus predicting how many impressions certain content will receive given targeting criteria is not an easy problem to solve.

Traditionally, online content platforms perform offline simulations to predict impression counts. For example, the online content platform stores past usage histories (e.g., pageviews) for users of the online content platform. This is stored as a time series—a set of timestamps recording times which the user viewed a page that serves content for a campaign. The online content platforms periodically precompute, for desired particular combinations of targeting criteria, the predicted impressions using this timestamp data. In order to simulate frequency caps, the online content platforms use a plurality of predetermined frequency caps. These results are saved and later presented in a user interface provided by the online content platform when a content provider is attempting to setup or modify a campaign. Thus, in the traditional system, content providers can only see the predicted page views and frequency cap impacts of a predetermined number of selectable frequency caps. It is not possible to pre-compute every possible targeting criteria combination along with every possible frequency cap.

For example, if the targeting criteria is underwater basket weavers in North Dakota, and there are three users of the online content platform that match that criteria, the three users may have time series of:
User 1: T1 (10:43 a.m. 11/03/2015), T2 (11:30 a.m. 11/03/2015), T3 (11:33 a.m. 11/04/2015)
User 2: T1 (9:03 a.m. 11/03/2015), T2 (9:05 a.m. 11/04/2015), T3 (9:45 a.m. 11/04/2015)
User 3: T1 (8:56 a.m. 11/03/2015), T2 (9:09 a.m. 11/04/2015), T3 (9:55 a.m. 11/05/2015)

The total number of estimated impressions for the period of 11/03-11/05 is 9. The system then discounts this for a number of predetermined frequency caps. For example, a frequency cap of once per day yields an adjusted total number of estimated impressions of 7. For example, User 1's impression at T2 is not counted as it violates the frequency cap. Likewise, User2's impression at T3 is not counted as it violates the frequency cap. None of user 3's impressions violate the frequency cap, for a total of 7 impressions (e.g., 9 impressions−2 removed=7 impressions when the frequency cap is applied). The system may also precompute a few select other frequency caps, such as twice per day, or once every third day.

In an online content platform such as a social network with many millions of users, and many possible combinations of targeting criteria, the online content platform does not have the computational power or the data storage space to calculate and store impression predictions for an infinite number of different possible frequency caps. Thus, content providers are not provided with accurate predictions for frequency caps that are not one of the predetermined frequency caps.

Disclosed in some examples, are methods, systems, and machine readable mediums which allow for providing estimated impressions for content given arbitrary frequency caps supplied by content providers. Time series historical visit data about each targeted user group is condensed by calculating, for users in a targeted user group, an arrival rate. The arrival rates for the users in the targeted user group are used to construct a distribution of arrival rates in the user group. This reduces a large amount of user time series data to a smaller number of statistical data. In some examples, these steps may be done offline. At the time a content provider is setting up a campaign or modifying a campaign (online), given an arbitrary frequency cap, the system samples a large number of arrival rates N from the targeted user group. For each of the N sampled arrival rates, a time series corresponding to the arrival rate is created from that arrival rate using a Poisson process and a frequency cap is applied to the sampled time series' to arrive at an estimated impression count. Adding up the frequency capped impressions for each sampled arrival rate and normalizing it for the number of members in the targeted population yields a prediction of the number of impressions in a given time period. This allows the online content platform to provide additional flexibility in allowing arbitrary frequency caps.

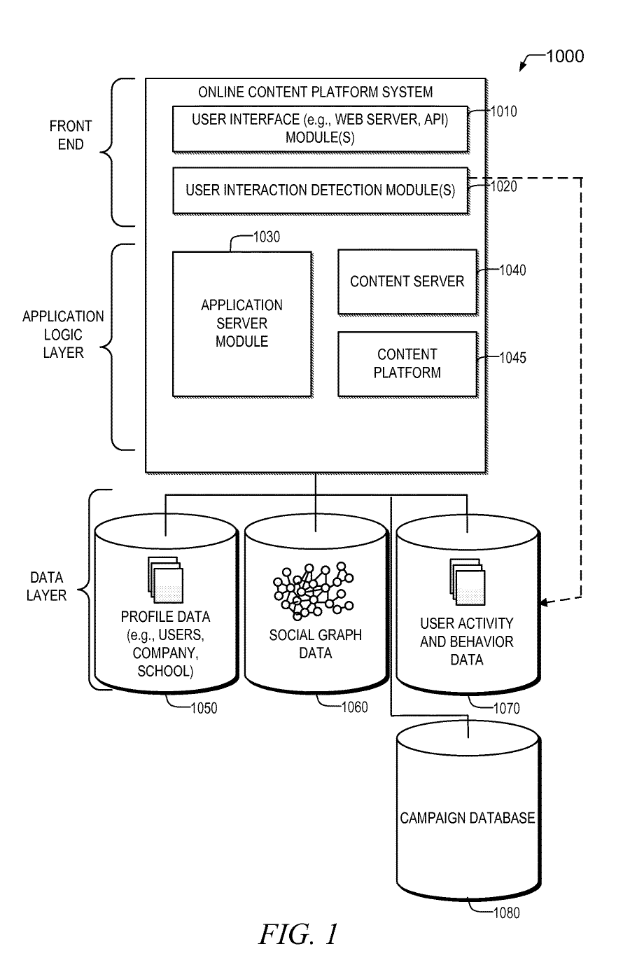

FIG. 1 is a block diagram showing the components of an online content platform 1000 (such as a social networking service). As shown in FIG. 1, a front end may comprise a user interface module (e.g., a web server) 1010, which receives requests from various client-computing devices, and communicates appropriate responses to the requesting client devices. For example, the user interface module(s) 1010 may receive requests in the form of Hypertext Transport Protocol (HTTP) requests, or other network-based, application programming interface (API) requests (e.g., from a dedicated social networking service application running on a client device). In addition, a user interaction and detection module 1020 may be provided to detect various interactions that users of the online content platform 1000 have with different applications, services and content presented. As shown in FIG. 1, upon detecting a particular interaction, the user interaction and detection module 1020 logs the interaction, including the type of interaction and any meta-data relating to the interaction, in the user activity and behavior database 1070. Example interactions include time stamps in a time series corresponding to the particular user.

An application logic layer may include one or more various application server modules 1030, which, in conjunction with the user interface module(s) 1010, generate various graphical user interfaces (e.g., web pages) with data retrieved from various data sources in the data layer. With some embodiments, application server modules 1030 implement the functionality associated with various applications and/or services provided by the online content platforms as discussed herein, such as a social networking service.

Application logic layer may also include content server 1040 which may work with user interface module 1010 to serve content submitted by content providers when users request one or more web pages from the user interface modules 1010. The content may be selected by comparing the user that is requesting the webpage with one or more targeting criteria of a campaign and selecting content from one of the matching campaigns. The selection may be done subject to frequency caps that limit the amount of times a particular piece of content from a campaign may be shown to a user.

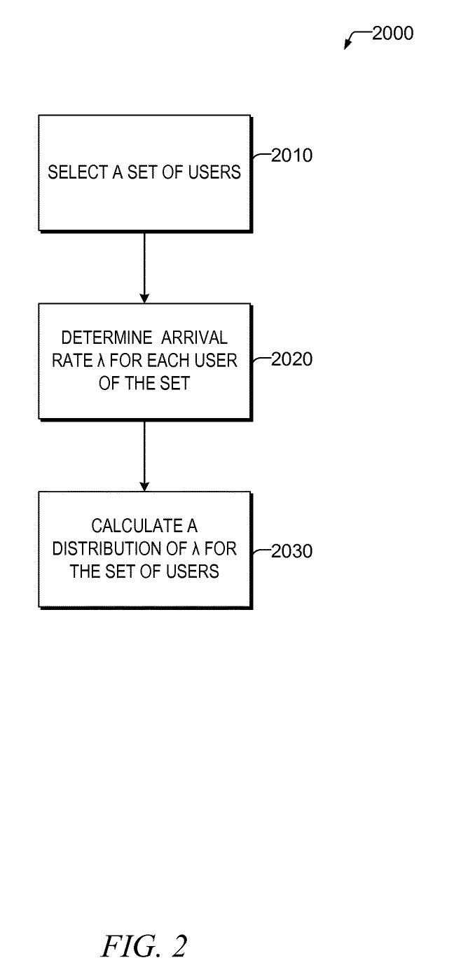

Application logic layer may also include a content platform 1045 which may provide one or more user interfaces through user interface modules 1010 to provide content providers with a user interface to create campaigns, upload content for the campaigns, specify targeting criteria, date ranges, and frequency caps. In the present disclosure, the frequency cap may be an arbitrary frequency cap. An arbitrary frequency cap is a frequency cap that is any desired frequency cap of the form: X impressions in Y time period, where X and Y are content provider input and are not predetermined. For example, the content provider may enter any value for X and Y they desire. In some examples, the content platform 1045 utilizes data in the user activity and behavior database 1070 to predict, given an arbitrary frequency cap and targeting criteria, an estimated number of impressions. The estimated number of impressions may be provided to the content provider via inclusion into a graphical user interface provided by the content platform 1045. For example, the content platform 1045 may be configured to perform the methods of FIGS. 2-4 discussed below. Content server 1040 and content platform 1045 may use and store data about campaigns in the campaign data base 1080.

The online content platform 1000 may include a data layer that may include several other databases, such as a database 1050 for storing user profile data, including both user profile attributes as well as profile data for various organizations (e.g., companies, schools, etc.). Consistent with some embodiments, a user may register with the online content platform, becoming a member of the online content platform. When registering, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 1050. Similarly, when a representative of an organization initially registers the organization with the online content platform, the representative is prompted to provide certain information about the organization. This information may be stored, for example, in the database 1050, or another database (not shown). With some embodiments, the profile data may be processed (e.g., in the background or offline) to generate various derived profile data. For example, if a user has provided information about various job titles that they have held with the same company or different companies, and for how long, this information can be used to infer or derive a user profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Information describing the various associations and relationships, such as connections that users establish with other users, or with other entities and objects are stored and maintained within a social graph in the social graph database 1060. Also, as users interact with the various applications, services and content made available via the online content platforms, the users interactions and behavior (e.g., content viewed, links or buttons selected, messages responded to, etc.) may be tracked and information concerning the user's activities and behavior may be logged or stored, for example, as indicated in FIG. 1 by the user activity and behavior database 1070.

With some embodiments, the online content platform 1000 provides an application programming interface (API) module with the user interface module 1010 via which applications and services can access various data and services provided or maintained by the social networking service. For example, using an API, an application may be able to request and/or receive one or more features of the online content platform. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the functions of the online content platform available to third party applications and services.

Turning now to FIG. 2, a method 2000 of offline, batch processing of data used to produce an estimated number of impressions is shown according to some examples of the present disclosure. The method of FIG. 2 may be performed for one or more potential combinations of targeting criteria, including, in some examples, each possible combination of targeting criteria. In these examples, FIG. 2 is performed using a group of users that match the particular combination of targeting criteria. Thus, if there are 900 possible combinations of targeting criteria, the method of FIG. 2 may be performed 900 times, on 900 (possibly) different sets of users. At operation 2010 a set of users is selected based upon the users matching the particular combination of targeting criteria. Targeting criteria may include a user's: name, address, geolocation, age, gender, job title, job history, industry, skills, educational history, connections (e.g., friends as indicated on the online content platform), and the like.

At operation 2020, the system determines for each member of the set of users determined in operation 2010 an arrival rate λ. The arrival rate may be determined based upon a calculation:

$$\frac{Number of arrivals}{Timestamp Now - Timestamp of First Arrival}$$

The arrival rate is the number of arrivals for a user divided by the difference between the current time and the first time the user was observed on the online content platform. In other examples, the data used in this calculation may be some subset of all of the particular user's time series data. For example, the formula may be the number of arrivals for a user during a particular time period divided by the duration of the particular time period. In some examples, the unit of time may be days, thus the arrival rate λ may be in units of days.

This process condenses a large amount of data (a time series with potentially a large amount of timestamps for each user of the online content platform) into a single number λ for each user. Then, at operation 2030 this information is reduced further by calculating a distribution of λ for the set of users. The distribution is a function that describes the number of users in the set of users that have a particular arrival rate. The distribution may be calculated using a maximum likelihood estimation and may produce the function Gamma(α,β). For example, α, β should maximize P(λ|α, β)*P(number of arrivals of user j on day i|λ) for all user j on day i, where P(λ|α, β) follows gamma distribution and P(number of arrivals of user j on day i|λ) follows a Poisson distribution.

Once the pair of [α,β] are determined for each set of members, the estimated impressions for a particular targeted set of members may be estimated for arbitrary frequency cap rules. All that needs to be stored for a particular set of members that corresponds to a particular combination of targeting criteria is the pair of [α,β]. From those parameters, the actual timestamp data may be statistically reconstructed.

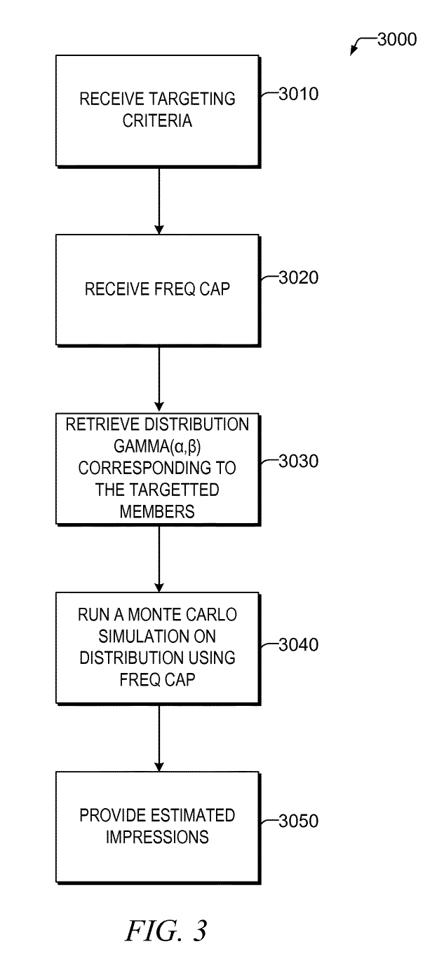

Turning now to FIG. 3, a flowchart of a method of providing estimated impressions given an arbitrary frequency cap 3000 is shown according to some examples of the present disclosure. The operations of FIG. 3, may be performed “online”—i.e. “on demand.” At operation 3010 the targeting criteria is received from the content providers. This may be received as a result of a selection or input into one or more graphical user interfaces provided by the online content platforms, such as through a content platform 1045 of FIG. 1. At operation 3020 the frequency cap that the content provider is interested in is received. This may be received as a result of a selection or input into one or more graphical user interfaces provided by the online content platforms, such as through a content platform 1045 of FIG. 1. The frequency cap may be arbitrarily chosen by the content provider (who may be a third party to the online content platform).

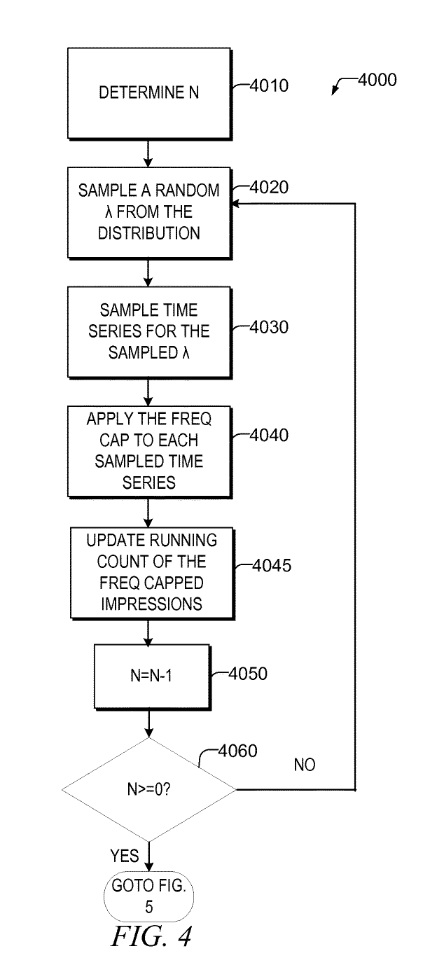

At operation 3030 the pre-computed distribution for the set of targeted members Gamma(α,β) is retrieved from storage, such as campaign database 1080 or some other data store. At operation 3040 the system runs a monte-carlo simulation on the distribution using the received frequency cap. FIG. 4 explains the monte-carlo simulation in depth. In short, the system draws a large number N of random λ from the distribution. For each λ, the system reconstructs a time series and then applies the frequency cap to that reconstructed time series to remove incidences of the time series that violate the frequency cap. The reconstructed time series' from each of the N random λ are then summed and normalized for the number of members in the targeted set of members. At operation 3050 the estimated number of impressions may then be provided to the content providers, for example, through a graphical user interface provided by the content platform 1045.

Turning now to FIG. 4, a flowchart of a method of the monte-carlo simulation of operation 3040 is shown according to some examples of the present disclosure. At operation 4010 the system determines N, where N is the number of random samples of λ used to produce the time series data. N may be predetermined, or it may be selected based upon some multiple of the number of members that match the targeting criteria. For example, N may be the number of members that match the targeting criteria*0.5. At operation 4020 the system samples a random λ from the distribution. At operation 4030, a time series is sampled for the X determined in 4020. The time series may be created based upon a Poisson function such as:

$$Δ T = \frac{- ln Random ( 0 , 1 )}{λ}$$

Where ln is the natural log, and Random(0,1) returns a random number between 0 and 1. ΔT is the difference in time between the preceding timestamp and the next timestamp, starting at 0. The system generates timestamps until the end of the desired sampled time period is reached. Thus, for example, if the λ=2.64518599989 (2.645 . . . times per day) one possible produced time series which describes possible arrivals (impressions) for a user in the targeted member group is:
Seq: [0.67852837124357868, 0.73903006160111351, 1.0199253085593469, 1.2944168435718777, 1.6430213787416736, 2.040858044089271, 2.0917926259234201, 3.687235952168558, 3.7720902478428244, 3.794732705719039, 3.8721253770019111, 4.7848998994939578, 4.8538413237260265, 4.8845433553746433, 5.2946013783489985, 5.6821122248392619, 6.0384269469941838, 6.1992557735503304, 6.964482812324964, 7.0626755752993287, 7.3266600257114103, 7.6454283060507899, 7.9988673362187708, 8.3583718877809901, 8.4123021849055224, 8.4869104412254863, 8.5343626024747223, 8.6250200056404349, 9.6158140226939217, 10.115361421125648, 10.254232574946389, 10.388111509987171, 10.692402830200709, 10.736218148800093, 11.175909695555729, 11.229601624101289, 11.990557837633636, 12.376314836978613, 12.749680969791902, 12.904172018129376, 13.537539481931406, 13.803421255120799, 14.175613866744945]
   Where the unit of time is days (e.g., seq[0]=0.67852837124357868 days from the beginning of the time period). The above time stamps correspond to 43 potential impressions.

At operation 4040, the system applies the frequency cap to the sampled time series to remove impressions that violate the frequency caps. In some examples, there may be multiple frequency caps. For example, there may be a global level cap that defines the number of times X a user can see a particular item of content C in period Y. There may be a campaign level cap as well that defines that a member can only see a particular sponsored content C at most X times per Y period. A global level frequency cap is shared by all campaigns targeting the same member, whereas campaign level caps are specific to the campaign. Despite these differences, the current method treats each type the same using the same abstraction (e.g., number of times X a user may see C in period Y). For example, using the above example time series data, and given two example frequency caps—At most two times per 24 hour period, and at most 6 times per week, we remove the impressions that violate these frequency caps from the above time series to produce: Capped Seq: [0.67852837124357868, 0.73903006160111351, 2.040858044089271, 2.0917926259234201, 3.687235952168558, 3.7720902478428244, 7.9988673362187708, 8.3583718877809901, 9.6158140226939217, 10.115361421125648, 10.692402830200709, 10.736218148800093]. Note that the frequency cap starts from the first impression (not from zero). Thus, between 0.67852837124357868, and 1.67852837124357868 there can only be two impressions, thus possible impressions at [1.0199253085593469, 1.2944168435718777, 1.6430213787416736] are frequency capped and are removed.

Likewise, between 0.67852837124357868, and 7.67852837124357868 there can be at most 6 impressions. Thus, [3.8721253770019111, 4.7848998994939578, 4.8538413237260265, 4.8845433553746433, 5.2946013783489985, 5.6821122248392619, 6.0384269469941838, 6.1992557735503304, 6.964482812324964, 7.0626755752993287, 7.3266600257114103, 7.6454283060507899] are removed for violating the 6 impressions per week frequency cap.

Once an impression at 7.9988673362187708 is shown, there can be only one other impression until 8.9988673362187708, which happens at 8.3583718877809901, thus [8.4123021849055224, 8.4869104412254863, 8.5343626024747223, 8.6250200056404349] are removed.

Once an impression at 9.6158140226939217 is shown, there can be only one other impression until 10.6158140226939217, which happens at 10.115361421125648, therefore [10.254232574946389, 10.388111509987171] are removed.

Between 10.692402830200709 and 11.692402830200709, only one more impression may be shown, which happens at 10.736218148800093, thus [11.175909695555729, 11.229601624101289] are removed.

Between 7.67852837124357868 and 14.67852837124357868, there can be at most 6 impressions, which has now been met, meaning that the rest of the time series is excluded.

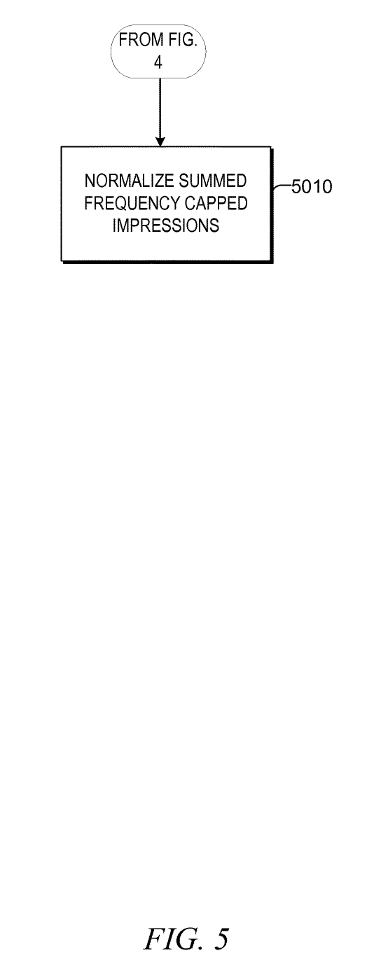

Thus, 43 impressions are capped to 12 impressions for this particular sampled λ. At operation 4045, the number of impressions that remain after timestamps in the time series that violate the frequency cap are removed is added to a running total of all such impressions for all sampled λ for all N. At operation 4050, N is decremented and a check is made at operation 4060 to determine if N>=0. If N>=0 then operations 4020-4060 are repeated until N is <=0. Once N is <=0, then operation proceeds to FIG. 5.

Turning now to FIG. 5, a flowchart of a method of the monte-carlo simulation is shown according to some examples of the present disclosure. FIG. 5 continues from FIG. 4. At operation 5010 the running count of total impressions is normalized for the population size of the targeted group. In some examples, this may be done by dividing the running count of valid impressions by N and then multiplying by the number of users in the targeted set of users. This normalized estimation of the impressions may then be presented to the content provider, in some examples, through a graphical user interface.

### FORMAL DEFINITIONS

Assume we have a set of time series' measuring the view count V on page P about a user's segment U (a user segment is the set of users matching the targeting criteria):

Vₚ_{ₓ}_{,u}={Vₜ:tεT|P=pₓ,U=u}

Given a set of pages Pₓ={p₁, p₂, p₃, . . . }, a particular user segment U and a set of Frequency Cap (Fcap) rules F_{y}={F₁, F₂, F₃, . . . } we want to compute a time series of S representing the supply of inventory of sponsored content C, which can be placed on P_{X} and subject to F_{Y}. S_{C}={Sₜ: tεT}. As noted, a user segment is a set of users that share some properties (e.g., match targeting criteria) such as age, language, gender, and the like. A time series is a series of values on a time axis. Forecasting may be done by historical patterns. Supply inventory is a measure of how many impressions of a content can be delivered when targeted to a user segment. V is a set of time series describing pageview count per day and is prepared offline. The method makes the assumptions that page view arrivals are independent of each other and that each page can only show the same item of content once.

As already noted, we have two different types of frequency cap, a global level cap, which is denoted as

$${F}_{g} \frac{X}{Y}$$

and a campaign/creative level cap, denoted as

$${F}_{c} \frac{X}{Y}$$

where X is the frequency and Y is the time period. In some examples, Y is in the granularity of days.

In order to simulate arrivals on a particular page given a user segment, a probabilistic model (PGM) is build. First, for each member, we assume that arrivals on a page are independent events and the probability of a given number of arrivals occurring in a fixed period of time is a Poisson distribution. Thus we have:

Arrivalsₘ˜Poisson(λ), where λ is the arrivals rate.

Since the arrivals rate on a page is not constant, but is a function of time, we do not have an observation on each time point, when we bucket the arrivals into granularity levels (e.g., daily), we will have the arrivals rate as a time series, and the arrivals distribution as a set of Poisson distributions along time.

λ={λₜεT},Arrivals_{m,t}˜Poisson(λₜ)

For each user segment we assume the λ of these members is a known distribution G(λ) (as noted, λ is a time series instead of a constant). In order to compute a time series of a λ, we assume that its distribution traits do not change along time, but only scale a constant factor. So, we can estimate G(λ̅) with a long period of time and do projection to restore a particular λₜ.

In the period T (by any granularity—e.g., daily), by the definition of the arrival rate, we have T*λ̅=λₜ Assuming that the original page view count time series by this granularity is PVₜ, we have λₜ˜PVₜ so:

$${λ}_{t} = \frac{T \overline{λ} * {PV}_{t}}{{\sum }_{t}^{T} {PV}_{t}}$$

So for each user, we know their arrival rate as λ, and we want to generate a list of ΔT representing the interval of two occurrence of arrivals. First, lets assume that λ is a constant. By the definition of λ we can define the probability of one or more arrivals in AT as the cumulative distribution function (CDF) of the exponential distribution:

F(x)=1−e^{-λΔT}

Reversing the CDF, we can have a generate function to generate the series of ΔT as:

$$Δ T = \frac{- ln Random ( 0 , 1 )}{λ}$$

Now, the reality is that λ is a series. Also, we apply the definition dependent event, the probability of at least an arrival happening during time x which is a piecewise function as follows:

F(x)=1−(Πₜ^{T-1}(e^{-λ}^{ₜ}))(e^{-λ}^{ₜ}^{(x-T+1)}),T=ceil(x)

Hence, the generate function will be a case of an inverse of the piecewise function above: F⁻¹ (Random(0,1))

Separating the product term and taking the log of both sides, we have:

$$δ t = ( T - 1 ) + \frac{- ln ( 1 - F ( x ) ) - {\sum }_{t}^{T - 1} {λ}_{t}}{{λ}_{t}}$$

So, our model is G(λ)→Poisson(λ)→{ΔT}

Now, to estimate G(λ) we assume that the arrival rate λ of a user segment is log normal distributed:

λ˜ln N(μ,σ²)

Using maximum likelihood estimation, we simply aggregate the log of arrival rate and the square of it. So we have:

$$μ \sim \frac{\sum ln ( λ )}{N} , {σ}^{2} \sim \frac{\sum {( ln ( λ ) - μ )}^{2}}{N - 1} = \frac{\sum {ln ( λ )}^{2}}{N - 1} - \frac{N * {μ}^{2}}{N - 1}$$

Next we will simulate an arbitrary frequency cap on content which can only be served on a particular page P, and subject to only the campaign/creative level frequency cap first (we will extend the method to a global level cap later) of

$${F}_{c} \frac{X}{Y} .$$

Assuming we already know G(λ), representing the arrivals rate of a given user segments on page P, our method has four main steps:
1.) Draw N members from our target user segments. We will have Nλ representing the arrivals rate of each member. The size of N depends on the time allocated to complete the simulation.
2.) Using the generate function to generate time series'

$$Δ T = \frac{- ln Random ( 0 , 1 )}{λ}$$

We generate N sequences of ΔT until ΣΔT≧Tₙ−T₀ Thus, we generate N sequences of arrivals which are long enough to determine an estimated number of impressions for the content provider's query.
3.) By summing up the sequences of ΔT we transform the time intervals to a sequence of time points.
4.) For each sequence of arrivals S, we apply the Fcap rules removing points that violate the rules and yield a sub-sequence of S.
5.) Finally, we bucket thel sequences of time back to time series of the view count. Take the average of them, and multiply by the real segment size. This is the time series of supply.

Now, to extend to the global frequency cap we introduce a few changes. The difference between the campaign level caps and global caps is that the campaign level cap won't consider past activities. The current campaign is only capped by itself, so we can start our simulation at T₀. For a global cap, users may already have been subject to a cap because there other existing campaigns running with the same content. In order to measure the discounting Fcap effect of other campaigns at the global level, we start our simulation earlier than Tₙ. The starting time of the simulation is:

T₀−MAX({RETENTION TIME_{F}}).

Retention time is the amount of time that time series data is retained for (e.g., visit records expire after a predetermined time period) The underlying assumption for this approach is that the global cap effect has reached a stationary status.

Now, a more detailed look at an example algorithm to apply the Fcap rules to the sequence of arrivals S. The input of the algorithm is a time sequence S and a set of Fcap rules F. Each rule in F states that X/Y means that at most X during Y time period. Lets assume that ∥S∥=L, ∥F∥=M, then the steps of the algorithm are:

1. For each f in F, we initialize a queue by calling an initialization function—say: cacheQueue[f].

2. Initialize an array: subS=[ ]

3. Loop through all points in S and do the following.
a For each point mark its value as s.
b Deque the rearest element from each cacheQueue[f] until the cacheQueue is empty or the rearest element >s−Y[f] (where Y is the length for an frequency cap (e.g., 3 days) and x is the cap count of the f cap).
c Loop through all fcap f, check whether all cacheQueue[f] size <f[x]; if so, set allowinsert to True, otherwise false.
d If allowinsert is True, add s to subS, add s to each cacheQueue of F.

The complexity of the above algorithm on a single sequence S is O(L*M), and because the whole simulation process generates N sequences, the total simulation complexity is O(L*N*M). We know that L is the length of the sequence which is generated from a poisson process with arrival rate of λ. So L=∥T∥λ which T is the length of the original page view time series s. Considering λ is a constant for a fixed sample, the total time complexity is O(T*N*M), bounded by the length of the time series, resample size, and cardinality of the frequency caps.

### Machine Example

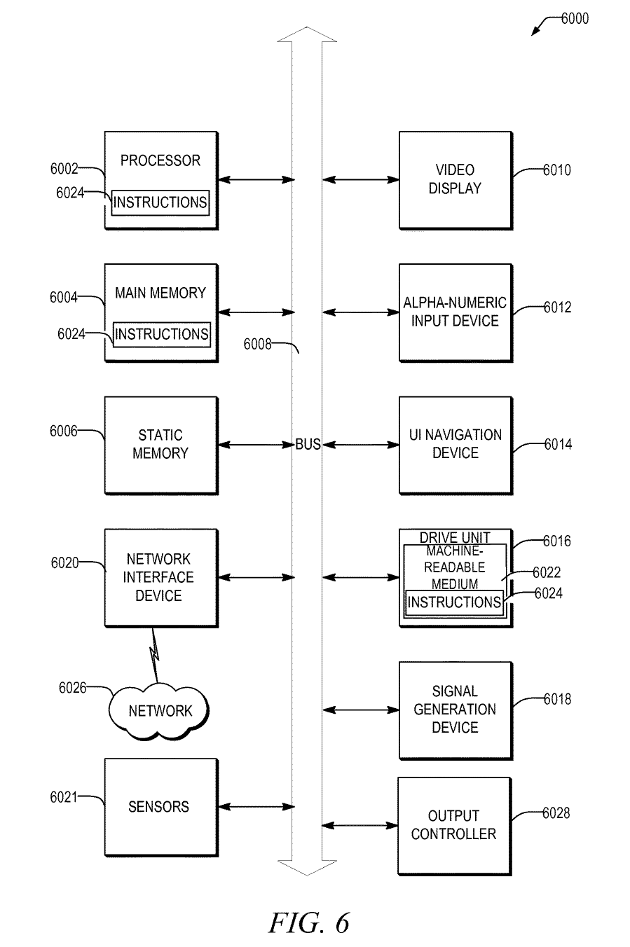

FIG. 6 illustrates a block diagram of an example machine 6000 upon which any one or more of the techniques (e.g., methodologies) discussed herein may perform. In alternative embodiments, the machine 6000 may operate as a standalone device or may be connected (e.g., networked) to other machines. In a networked deployment, the machine 6000 may operate in the capacity of a server machine, a client machine, or both in server-client network environments. In an example, the machine 6000 may act as a peer machine in peer-to-peer (P2P) (or other distributed) network environment. The machine 6000 may be a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. The machine may implement an online content platform such as shown in FIG. 1. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 6000 may include a hardware processor 6002 (e.g., a central processing unit (CPU), a graphics processing unit (GPU), a hardware processor core, or any combination thereof), a main memory 6004 and a static memory 6006, some or all of which may communicate with each other via an interlink (e.g., bus) 6008. The machine 6000 may further include a display unit 6010, an alphanumeric input device 6012 (e.g., a keyboard), and a user interface (UI) navigation device 6014 (e.g., a mouse). In an example, the display unit 6010, input device 6012 and UI navigation device 6014 may be a touch screen display. The machine 6000 may additionally include a storage device (e.g., drive unit) 6016, a signal generation device 6018 (e.g., a speaker), a network interface device 6020, and one or more sensors 6021, such as a global positioning system (GPS) sensor, compass, accelerometer, or other sensor. The machine 6000 may include an output controller 6028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 6016 may include a machine readable medium 6022 on which is stored one or more sets of data structures or instructions 6024 (e.g., software) embodying or utilized by any one or more of the techniques or functions described herein. The instructions 6024 may also reside, completely or at least partially, within the main memory 6004, within static memory 6006, or within the hardware processor 6002 during execution thereof by the machine 6000. In an example, one or any combination of the hardware processor 6002, the main memory 6004, the static memory 6006, or the storage device 6016 may constitute machine readable media.

While the machine readable medium 6022 is illustrated as a single medium, the term “machine readable medium” may include a single medium or multiple media (e.g., a centralized or distributed database, and/or associated caches and servers) configured to store the one or more instructions 6024.

The term “machine readable medium” may include any medium that is capable of storing, encoding, or carrying instructions for execution by the machine 6000 and that cause the machine 6000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 6024 may further be transmitted or received over a communications network 6026 using a transmission medium via the network interface device 6020. The Machine 6000 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 6020 may include one or more physical jacks (e.g., Ethernet, coaxial, or phone jacks) or one or more antennas to connect to the communications network 6026. In an example, the network interface device 6020 may include a plurality of antennas to wirelessly communicate using at least one of single-input multiple-output (SIMO), multiple-input multiple-output (MIMO), or multiple-input single-output (MISO) techniques. In some examples, the network interface device 6020 may wirelessly communicate using Multiple User MIMO techniques.

What is claimed is:

1. A method comprising:
using a computer processor:
determining an arrival rate for each particular user in a set of users of an online content platform based upon the particular user's usage history of the online content platform, the arrival rates quantifying a frequency of page views of a particular page of the online content platform;
creating a distribution function of the arrival rates for the set of users;
sampling a plurality of random arrival rates from the distribution function;
for each particular one of the plurality of sampled arrival rates:
reconstructing a time series for the particular one of the plurality of sampled arrival rates based upon the particular one of the plurality of sampled arrival rates; and
applying a frequency cap to the time series;
keep a running total across all of the plurality of sampled arrival rates of the number of remaining time stamps after the frequency cap is applied;
normalizing the running total based upon a number of users in the set of users; and
displaying the running total as an estimated number of impressions as part of a graphical user interface.

2. The method of claim 1, comprising:
determining the set of users based upon each user in the set of users matching targeting criteria, the targeting criteria comprising one or more targeted user attributes.

3. The method of claim 2, comprising:
for each possible combination of targeting criteria:
determining a particular set of users that match the targeting criteria; and
performing the determination of the arrival rates and storing in a computer memory the distribution function for the particular set of users;
receiving targeting criteria from a content provider; and
retrieving the distribution function from the computer memory for the particular set of users that match the received targeting criteria as the distribution used for sampling the plurality of random arrival rates.

4. The method of claim 3, wherein the frequency cap is received from a content provider.

5. The method of claim 4, wherein the frequency cap is arbitrarily chosen by the content provider.

6. The method of claim 1, wherein the arrival rate and the distribution function is precomputed and wherein the sampling the plurality of random arrival rates is performed in response to a request by a content provider.

7. The method of claim 1, wherein the frequency cap specifies a maximum number of impressions for a given user that can be displayed for a given unit of time.

8. A non-transitory machine readable medium that stores instructions which when performed by a machine, cause the machine to perform operations comprising:
determining an arrival rate for each particular user in a set of users of an online content platform based upon the particular user's usage history of the online content platform, the arrival rates quantifying a frequency of page views of a particular page of the online content platform;
creating a distribution function of the arrival rates for the set of users;
sampling a plurality of random arrival rates from the distribution function;
for each particular one of the plurality of sampled arrival rates:
reconstructing a time series for the particular one of the plurality of sampled arrival rates based upon the particular one of the plurality of sampled arrival rates; and
applying a frequency cap to the time series;
keep a running total across all of the plurality of sampled arrival rates of the number of remaining time stamps after the frequency cap is applied;
normalizing the running total based upon a number of users in the set of users; and
displaying the running total as an estimated number of impressions as part of a graphical user interface.

9. The machine readable medium of claim 8, wherein the operations comprise:
determining the set of users based upon each user in the set of users matching targeting criteria, the targeting criteria comprising one or more targeted user attributes.

10. The machine readable medium of claim 9, wherein the operations comprise:
for each combination of targeting criteria:
determining a particular set of users that match the targeting criteria; and
performing the determination of the arrival rates and storing in a computer memory the distribution function for the particular set of users;
receiving targeting criteria from a content provider; and
retrieving the distribution function from the computer memory for the particular set of users that match the received targeting criteria as the distribution used for sampling the plurality of random arrival rates.

11. The machine readable medium of claim 10, wherein the frequency cap is received from a content provider.

12. The machine readable medium of claim 11, wherein the frequency cap is arbitrarily chosen by the content provider.

13. The machine readable medium of claim 8, wherein the arrival rate and the distribution function is precomputed and wherein the sampling the plurality of random arrival rates is performed in response to a request by a content provider.

14. The machine readable medium of claim 8, wherein the frequency cap specifies a maximum number of impressions for a given user that can be displayed for a given unit of time.

15. A system comprising:
a computer processor;
a non-transitory memory that stores instructions which when performed by the computer processor, causes the computer processor to perform operations comprising:
determining an arrival rate for each particular user in a set of users of an online content platform based upon the particular user's usage history of the online content platform, the arrival rates quantifying a frequency of page views of a particular page of the online content platform;
creating a distribution function of the arrival rates for the set of users;
sampling a plurality of random arrival rates from the distribution function;
for each particular one of the plurality of sampled arrival rates:
reconstructing a time series for the particular one of the plurality of sampled arrival rates based upon the particular one of the plurality of sampled arrival rates; and
applying a frequency cap to the time series;
keep a running total across all of the plurality of sampled arrival rates of the number of remaining time stamps after the frequency cap is applied;
normalizing the running total based upon a number of users in the set of users; and
displaying the running total as an estimated number of impressions as part of a graphical user interface.

16. The system of claim 15, wherein the operations comprise:
determining the set of users based upon each user in the set of users matching targeting criteria, the targeting criteria comprising one or more targeted user attributes.

17. The system of claim 16, wherein the operations comprise:
for each combination of targeting criteria:
determining a particular set of users that match the targeting criteria; and
performing the determination of the arrival rates and storing in a computer memory the distribution function for the particular set of users;
receiving targeting criteria from a content provider; and
retrieving the distribution function from the computer memory for the particular set of users that match the received targeting criteria as the distribution used for sampling the plurality of random arrival rates.

18. The system of claim 17, wherein the frequency cap is received from a content provider.

19. The system of claim 18, wherein the frequency cap is arbitrarily chosen by the content provider.

20. The system of claim 15, wherein the arrival rate and the distribution function is precomputed and wherein the sampling the plurality of random arrival rates is performed in response to a request by a content provider.

21. The system of claim 15, wherein the frequency cap specifies a maximum number of impressions for a given user that can be displayed for a given unit of time.
